(19) United States
(12) Patent Application Publication
(10) Pub. No.: US 2015/0323161 A1
(43) Pub. Date: Nov. 12, 2015

(54) LIGHT FIXTURE HARP ADAPTER

(71) Applicant: Hollymount, Ltd., North Chatham, NY (US)

(72) Inventor: Joseph Williamson, North Chatham, NY (US)

(73) Assignee: Hollymount, Ltd., North Chatham, NY (US)

(21) Appl. No.: 14/272,140

(22) Filed: May 7, 2014

(51) Int. Cl. F21V 17/04; F21V 17/12

(52) U.S. Cl. CPC F21V 17/04; F21V 17/12

(57) ABSTRACT

A light fixture harp for securing to a cylindrical portion of a light fixture to attach a lampshade to the light fixture. The light fixture harp comprise a cylindrical collar having an inner vertical wall for securing the cylindrical collar against the cylindrical portion of the light fixture, a clamp for reducing the circumference of the cylindrical collar to clamp the cylindrical collar to the light fixture, a wire frame attached to the cylindrical collar, and a shade rest secured to an upper end of the wire frame to retain the lampshade. The cylindrical collar circularly extends from a first flat end to a second flat end and comprises an inner vertical wall for securing the cylindrical collar against the cylindrical portion of the light fixture. The first flat end is substantially parallel with the second flat end, and the first and second flat ends comprise oppositely disposed holes, one of which is preferably threaded. A clamp screw is threaded into one of the first hole and the second hole to clamp the cylindrical collar to the light fixture.

### FIELD OF THE INVENTION

The present invention generally relates to the field of light fixtures, and more particularly, to a harp adapter for securing to a light fixture.

### BACKGROUND OF THE INVENTION

Light fixtures, such as lamps, wall sconces, and chandeliers, often use a lampshade to cover the light bulb to diffuse the emitted light. A typical lampshade available on the market is constructed using a frame having a spider fitter at its upper end to attach the lampshade to a harp provided on the light fixture. The spider fitter generally comprises two to three arms radially extending from the upper end of the frame to a central ring. The central ring attaches to a shade rest of the harp. In turn, the lamp harp is secured to the light fixture using a harp saddle. The harp saddle is secured to the neck of the light fixture right underneath the socket. However, in many cases, consumers may wish to add a lampshade to a light fixture that is not manufactured with a harp. For example, a consumer may wish to add a lampshade to diffuse the light of a light fixture manufactured without a lampshade. In other cases, a light fixture may be manufactured with an atypical lampshade and lampshade attachment (e.g., a lampshade that screws onto the lamp socket), and a consumers may wish to replace the lampshade with a newer or a different lampshade having a typical configuration.

While lamp harps are available on the market, the consumer is required to disconnect the socket from the light fixture to install the lamp harp to the light fixture. This is time consuming and may become costly as many inexperienced consumers will have to take the light fixture to an electrician to be disassembled. Various solutions have been introduced to solve the aforementioned problem. One such solution is in a form of a lamp harp having a saddle with a flat ring that fits over a threaded socket (such as a Uno socket) and held in place by a threaded ring. Other lamp harps may comprise a threaded harp saddle that can be threadably secured to a threaded socket of a light fixture. However, most lamps do not have threaded sockets. Another solution is a harp saddle having a ring that rests on the socket and is secured by the bulb. However, to utilize such a harp, the light fixture needs to have a socket with a rim or a bead for retaining the ring, otherwise the ring would simply slide down the socket. In addition, many lamps, such as candlestick lamps, may have smooth sleeves over the socket, preventing any such harps to be secured to the lamp. Instead of using a harp, a consumer may use a lampshade adapter in the form of a clip that clips onto the light bulb. However, such bulb clip adapters can be only used for miniature lampshades since they only slightly extend beyond the bulb. Because a lampshade should only cover the light bulb and the socket, a large lampshade secured to a bulb clip adapter would extend to cover a portion of the lamp itself. In addition, such bulb clip adapters tend to tilt the lampshade because of its weight and can be easily unclipped if a consumer accidentally bumps into the lamp or touches the lampshade, for example, to turn off the light fixture.

Therefore, there is a need for a harp adapter capable of securing to a light fixture that does not have an existing harp. In addition, there is a need for a harp adapter capable of securing to a light fixture with any type of socket.

### SUMMARY OF THE INVENTION

An object of the invention is to overcome the drawbacks of previous inventions.

Another object of the invention is to provide a novel and useful harp adapter capable of securing to a light fixture that does not have an existing harp.

Another object of the invention is to provide a harp adapter capable of securing to a light fixture with any type and sized socket.

Yet another object of the invention is to provide a harp adapter comprising a clamp for securing the harp adapter to any cylindrical portion of a light fixture, including, a light fixture neck, a light fixture arm, a light fixture socket, a candlestick sleeve, or the like.

Yet another object of the invention is to provide a harp adapter comprising a clamp for securing the harp adapter at any height along a cylindrical portion of a light fixture.

Another object of the invention is to provide a light fixture harp for securing to a cylindrical portion of a light fixture to attach a lampshade to the light fixture.

In a preferred embodiment, the light fixture harp comprises: a cylindrical collar having an inner vertical wall for securing the cylindrical collar against the cylindrical portion of the light fixture; a clamp for reducing the circumference of the cylindrical collar to clamp the cylindrical collar to the light fixture; a wire frame attached to the cylindrical collar, wherein the wire frame comprises a horizontal bridge section at the upper end of the wire frame; and a first vertical section and a second vertical section downwardly extending from the horizontal bridge section, and a shade rest secured to the horizontal bridge section to retain the lampshade.

In another embodiment, the light fixture harp comprises: a cylindrical collar having an inner vertical wall for securing the cylindrical collar against the cylindrical portion of the light fixture; a clamp for reducing the circumference of the cylindrical collar to clamp the cylindrical collar to the light fixture; a first arm and a second arm oppositely and upwardly extending from the cylindrical collar; a wire frame comprising a horizontal bridge section at the upper end of the wire frame, and a first vertical section and a second vertical section downwardly extending from the horizontal bridge section, wherein the first vertical section is removably attached to the first arm and wherein the second vertical section is removably attached to the second arm; and a shade rest secured to the horizontal bridge section to retain the lampshade.

In yet another embodiment, the light fixture harp comprises: a cylindrical collar circularly extending from a first flat end to a second flat end, wherein the cylindrical collar comprises an inner vertical wall for securing the cylindrical collar against the cylindrical portion of the light fixture, wherein the first flat end is substantially parallel with the second flat end, wherein the first flat end comprises a first hole and wherein the second flat end comprise a second hole, wherein the first hole is disposed opposite the second hole, wherein at least one of the first hole and the second hole is threaded; a clamp screw threaded into one of the first hole and the second hole to clamp the cylindrical collar to the light fixture; a wire frame attached to the cylindrical collar, wherein the wire frame comprises a horizontal bridge section at the upper end of the wire frame, and a first vertical section and a second vertical section downwardly extending from the horizontal bridge section; and a shade rest secured to the horizontal bridge section to retain the lampshade. Screwing the clamp screw into at least one of the first hole and the second hole decreases the diameter of the cylindrical collar, and unscrewing the clamp screw out of at least one of the first hole and the second hole increases the diameter of the cylindrical collar. The light fixture may be a lamp, a table lamp, a floor lamp, a wall sconce, a chandelier, a pendant, a vanity fixture, or the like. The cylindrical collar may be attached to any of the neck, socket, arm, a candlestick sleeve, or any other cylindrical portion of the light fixture. The cylindrical collar may comprise first and second arms vertically extending from the cylindrical collar at two oppositely disposed ends of the cylindrical collar. The first and second arms extending from the cylindrical collar may cooperate with the wire frame to attach the wire frame to the cylindrical collar. Alternatively, the wire frame may vertically extend from and be directly and permanently attached to the cylindrical collar.

### BRIEF DESCRIPTION OF THE DRAWINGS

A further understanding of the invention can be obtained by reference to a preferred embodiment, along with alternative embodiments, set forth in the illustrations of the accompanying drawings, where like reference numbers indicate like elements throughout the drawings. Although the illustrated embodiment is merely exemplary of systems and methods for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the invention, reference is now made to the following drawings in which:

FIG. 1 is a rear view of a light fixture harp adapter secured to a lamp according to a preferred embodiment of the invention;

FIG. 2A is a perspective front view of the light fixture harp adapter;

FIG. 2B is a top view of the light fixture harp adapter;

FIG. 3 is a rear view of a light fixture harp adapter according to an alternative embodiment of the invention;

FIG. 4 is a side view of a clamp screw for use with the light fixture harp adapter of the present invention; and

FIG. 5 is a perspective view of a light fixture harp adapter according to another alternative embodiment of the invention.

### DETAILED DESCRIPTION OF THE INVENTION

The invention may be understood more readily by reference to the following detailed description of preferred embodiment of the invention. However, techniques, systems and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. It must be noted that, as used in the specification and the appended claims, the singular forms “a”, “an”, and “the” include plural referents unless the context clearly indicates otherwise.

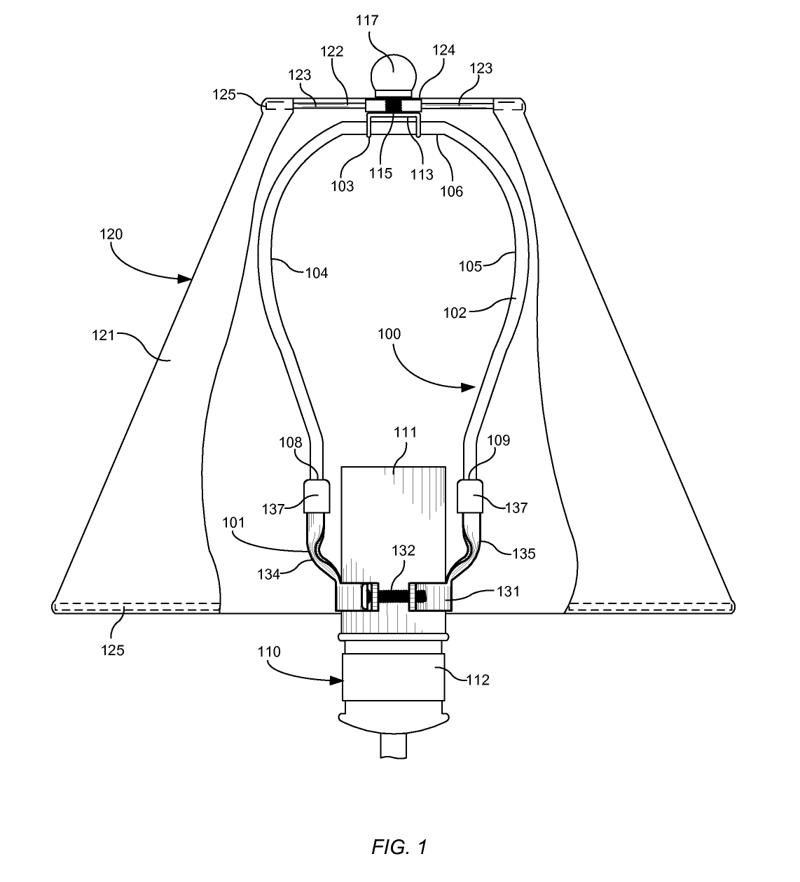

Referring now to FIG. 1, there is shown a rear view of a light fixture harp 100 made in accordance with the teachings of the preferred embodiment of the invention. The light fixture harp 100 may be used to secure a lampshade 120 to any light fixture 110 known in the art, including, but not limited to, a lamp, a table lamp, a floor lamp, a wall sconce, a chandelier, a pendant, a vanity fixture, or the like. Light fixture harp 100 may comprise any material known in the art, including metal, plastic, or composite materials. The light fixture 110 generally comprises a socket 111 secured to a neck 112. The socket 111 may be exposed or it may be covered by a candlestick sleeve, as shown. Lampshade 120 generally comprises a shell 121 formed by a frame 125 comprising a spider fitter 122 at the upper end of the lampshade 120. Spider fitter 122 includes arms 123 radially and inwardly extending from the upper end of the lampshade 120 to a shade ring 124. Although a particular lampshade configuration is illustrated, it should be appreciated that any lampshade configuration may be used that is capable of being secured to a harp.

Light fixture harp 100 comprises a harp saddle 101, a wire frame 102, and a shade rest 103. Wire frame 102 may extend from a first terminal end 108 to a second terminal end 109. Wire frame 102 may comprise a horizontal bridge section 106 at its upper end, from which a first vertical section 104 and a second vertical section 105 downwardly extend to be engaged with the harp saddle 101. First and second vertical sections 104 and 105 may comprise any desired length to complement any sized lampshade 120. Shade rest 103 is attached to the horizontal bridge section 106 and comprises a horizontal platform 113 and a threaded stud 115 transversely extending from the platform 113. Platform 113 and threaded stud 115 cooperate to retain the shade ring 124 of lampshade 120. A threaded finial 117 may be threaded onto the threaded stud 115 to secure the shade ring 124 of the lampshade 120 to the harp 100.

Harp saddle 101 comprises a cylindrical collar 131 for securing the harp saddle 101 to the light fixture 110. Two arms 134 and 135 vertically extend from the cylindrical collar 131 to be engaged with the wire frame 102. Sleeves 137 may be used to retain wire frame 102 with arms 134 and 135. As shown in FIG. 1, cylindrical collar 131 is clamped around the candlestick sleeve of socket 111 using a clamp screw 132. However, cylindrical collar 131 may fit around the circumference of any cylindrical portion of light fixture 110. For example, cylindrical collar 131 may fit around the lamp neck 112, directly around the socket 111, around a light fixture arm, or the like. In addition, cylindrical collar 131 may be clamped to the cylindrical portion of the light fixture 110 at any height allowing the consumer to adjust the height of the lampshade 120 with respect to the light fixture 110. Moreover, cylindrical collar 131 may be configured to be secured to any sized socket, including a mogul socket, a medium sized socket, an intermediate sized socket, a European sized socket, a candelabra socket, or mini candelabra socket. To achieve this, cylindrical collars 131 of various circumference sizes may be provided.

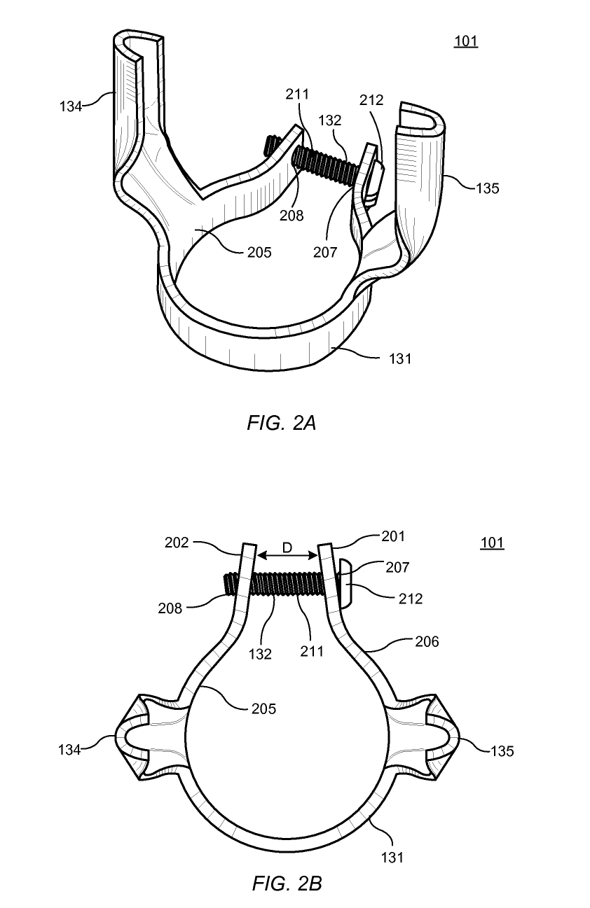

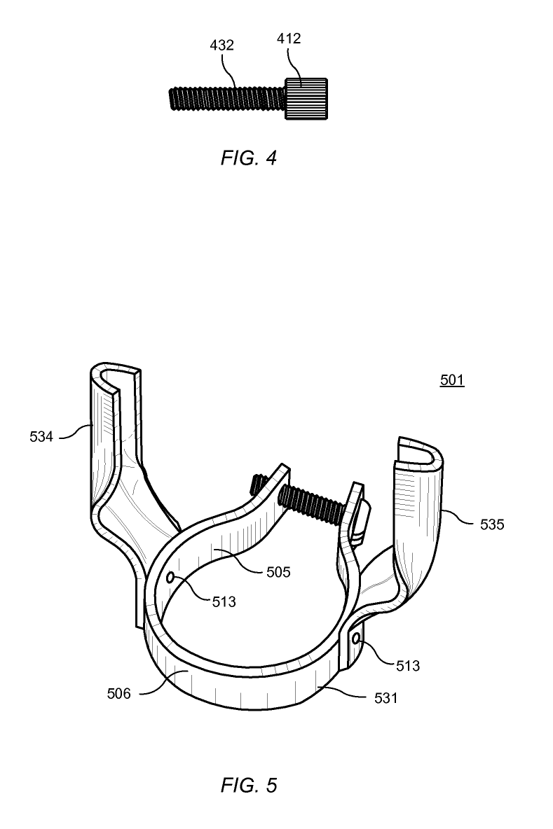

FIG. 2A illustrates a perspective front view and FIG. 2B illustrates is a top view of the harp saddle 101 in greater detail. As shown, harp saddle 101 comprises a cylindrical collar 131 circularly extending from a first flat end 201 to a second flat end 202. Cylindrical collar 131 comprises an inner vertical wall 205 for securing the cylindrical collar 131 against a cylindrical portion of the light fixture 110. In a preferred embodiment, the first flat end 201 is substantially parallel with the second flat end 202. Further, the first flat end 201 and the second flat end 202 comprise oppositely disposed first and second holes 207 and 208 for engagement with a clamp screw 132. Clamp screw 132 is used to clamp the cylindrical collar 131 to the cylindrical portion of the light fixture 110. Clamp screw 132 may comprise a threaded portion 211 attached to a head portion 212. Head portion 212 may comprise any means for engagement by a torque-transmitting tool, such as a screwdriver or a wrench. For example, head portion 212 may comprise slotted, Philips, or socket engagement, or it may comprise a square or hexagon shaped head. An alternative embodiment of a clamp screw 432 is shown in FIG. 4. Claim screw 432 may comprise a thumbscrew head 412 comprising a ribbed surface so that the clamp screw 432 may be engaged and manually rotated using the consumer's fingers. While a clamp screw 132 is shown to clamp cylindrical collar 131 to the cylindrical portion of the light fixture 110, cylindrical collar 131 may be clamped to the cylindrical portion of the light fixture 110 using other securing means, including, but not limited to, any kind of a clasp known in the art, a Velcro® strap, or the like.

Referring back to FIGS. 2A-2B, in a preferred embodiment, second hole 208 of second flat end 202 of the cylindrical collar 131 is threaded, while the first hole 207 of the first flat end 201 is not threaded. The threaded portion 211 of clamp screw 132 freely resides within the first hole 207 of the first flat end 201 and threadably engaged with the threaded second hole 208 of the second flat end 202. In a preferred embodiment, head portion 212 abuts the outer wall 206 of the first flat end 201. Screwing clamp screw 132 into the threaded second hole 208 decreases distance D between first flat end 201 and second flat end 202. Similarly, unscrewing clamp screw 132 from threaded second hole 208 increases distance D between first flat end 201 and second flat end 202. Increasing distance D increases the circumference of the cylindrical collar 131, and decreasing distance D decreases the circumference of the cylindrical collar 131.

Referring to FIGS. 1-2B, to secure light fixture harp 100 to socket 111 of light fixture 110, clamp screw 132 is unscrewed out of threaded second hole 208 of second flat end 202 to increase the circumference of the cylindrical collar 131, until the cylindrical collar 131 may be freely inserted over socket 111. Then cylindrical collar 131 is inserted over socket 111 and held at a desired height. Clamp screw 132 is then screwed into threaded second hole 208 of second flat end 202 to decrease the circumference of the cylindrical collar 131 and thereby clamp the cylindrical collar 131 onto socket 111.

As shown in FIG. 2A, the cylindrical collar 131 and arms 134 and 135 may be molded from a single piece of material. In an alternative embodiment, as shown in FIG. 5, the harp saddle 501 may be assembled from one or more sections. Specifically, arms 534 and 535 may be molded separately from the cylindrical collar 531. Arms 534 and 535 may be secured to an outer wall 506 of the cylindrical collar 531 via pins 513. It should be understood, however, that arms 534 and 535 may be secured to the cylindrical collar 531 in any way known in the art, including, but not limited to a solder, glue, screws, bolts, pins, or any combination thereof.

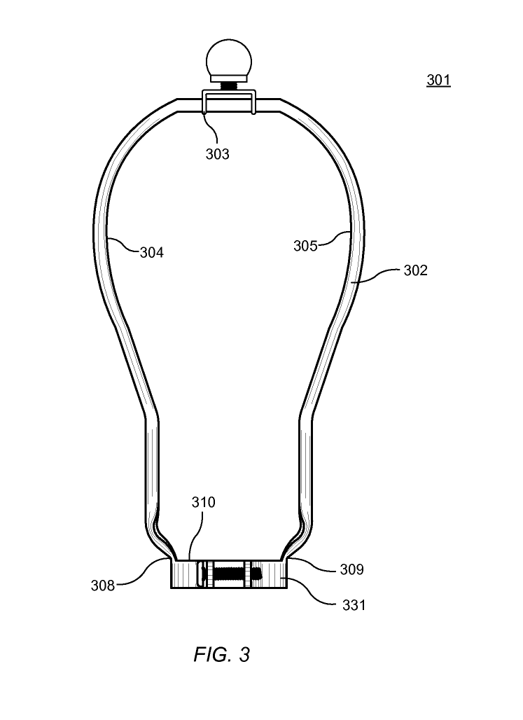

An alternative embodiment of the light fixture harp 301 is shown in FIG. 3. Light fixture harp 301 may comprise a single piece configuration. It may be molded as a single piece, or it may be molded from a plurality of sections that are permanently secured to each other. Light fixture harp 301 comprises a shade rest 303 secured to a wire frame 302 extending directly from a cylindrical collar 331. Wire frame 302 may comprise a horizontal bridge section 306 at its upper end, from which a first vertical section 304 and a second vertical section 305 downwardly extend to the cylindrical collar 331. First vertical section 304 vertically extends from an upper surface 310 of cylindrical collar 331 at a first end 308 and second vertical section 305 vertically extends from the upper surface 310 of cylindrical collar 331 at a second end 309. Cylindrical collar 331 secures the light fixture harp 301 to the light fixture 110. Since the entire light fixture harp 301 is removable, the light fixture harp 301 is not required to be separated into two or more separable pieces.

It should be understood that this invention is not limited to the disclosed features and other similar method and system may be utilized without departing from the spirit and the scope of the invention.

While the invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

1. A light fixture harp for securing to a cylindrical portion of a light fixture to attach a lampshade to the light fixture, comprising:
a cylindrical collar circularly extending from a first flat end to a second flat end, wherein the cylindrical collar comprises an inner vertical wall for securing the cylindrical collar against the cylindrical portion of the light fixture, wherein the first flat end is substantially parallel with the second flat end, wherein the first flat end comprises a first hole and wherein the second flat end comprise a second hole, wherein the first hole is disposed opposite the second hole, wherein at least one of the first hole and the second hole is threaded;
a clamp screw threaded into one of the first hole and the second hole to clamp the cylindrical collar to the light fixture;
a wire frame attached to the cylindrical collar, wherein the wire frame comprises a horizontal bridge section at the upper end of the wire frame, and a first vertical section and a second vertical section downwardly extending from the horizontal bridge section; and
a shade rest secured to the horizontal bridge section to retain the lampshade.

2. The light fixture harp of claim 1, wherein the light fixture comprises at least one selected from the group consisting of a lamp, a table lamp, a floor lamp, a wall sconce, a chandelier, a pendant, and a vanity fixture.

3. The light fixture harp of claim 1, wherein the shade rest comprises a horizontal platform and a threaded stud transversely extending from the horizontal platform.

4. The light fixture harp of claim 1, wherein the cylindrical collar further comprises a first arm and a second arm vertically extending from the cylindrical collar at two oppositely disposed ends of the cylindrical collar.

5. The light fixture harp of claim 4, wherein the first and second arms of the cylindrical collar are attached to the cylindrical collar via at least one selected from the group consisting of solder, glue, screws, bolts, pins, or any combination thereof.

6. The light fixture harp of claim 4, wherein the cylindrical collar and the first and second arms of the cylindrical collar comprise a single piece of material.

7. The light fixture harp of claim 4, wherein the first and second arms of the cylindrical collar cooperate with the wire frame to attach the wire frame to the cylindrical collar.

8. The light fixture harp of claim 7, where the wire frame further comprises at least one sleeve to retain the wire frame with at least one of the first and second arms of the cylindrical collar.

9. The light fixture harp of claim 1, wherein the wire frame is permanently attached to and vertically extends from the cylindrical collar.

10. The light fixture harp of claim 1, wherein the cylindrical portion of the light fixture comprises a neck, a socket, an arm, a candlestick sleeve, or a combination thereof.

11. The light fixture harp of claim 1, wherein the clamp screw comprises a threaded portion connected to a head portion.

12. The light fixture harp of claim 11, wherein the head portion comprises at least one selected from the group consisting of a slotted engagement, Philips engagement, a socket engagement, a square shaped head portion, a hexagon shaped head portion, and a thumbscrew head portion.

13. The light fixture harp of claim 1, wherein screwing the clamp screw into at least one of the first hole and the second hole decreases a diameter of the cylindrical collar, and wherein unscrewing the clamp screw out of at least one of the first hole and the second hole increases the diameter of the cylindrical collar.

14. A light fixture harp for securing to a cylindrical portion of a light fixture to attach a lampshade to the light fixture, comprising:
a cylindrical collar comprising an inner vertical wall for securing the cylindrical collar against the cylindrical portion of the light fixture;
a clamp for reducing the circumference of the cylindrical collar to clamp the cylindrical collar to the light fixture;
a wire frame attached to the cylindrical collar, wherein the wire frame comprises a horizontal bridge section at the upper end of the wire frame, and a first vertical section and a second vertical section downwardly extending from the horizontal bridge section; and
a shade rest secured to the horizontal bridge section to retain the lampshade.

15. A light fixture harp for securing to a cylindrical portion of a light fixture to attach a lampshade to the light fixture, comprising:
a cylindrical collar comprising an inner vertical wall for securing the cylindrical collar against the cylindrical portion of the light fixture;
a clamp for reducing the circumference of the cylindrical collar to clamp the cylindrical collar to the light fixture;
a first arm and a second arm oppositely and upwardly extending from the cylindrical collar;
a wire frame comprising a horizontal bridge section at the upper end of the wire frame, and a first vertical section and a second vertical section downwardly extending from the horizontal bridge section, wherein the first vertical section is removably attached to the first arm and wherein the second vertical section is removably attached to the second arm; and
a shade rest secured to the horizontal bridge section to retain the lampshade.
